(19) United States
(12) Patent Application Publication
(10) Pub. No.: US 2018/0197108 A1
(43) Pub. Date: Jul. 12, 2018

(54) SYSTEMS AND METHODS TO REDUCE FEATURE DIMENSIONALITY BASED ON EMBEDDING MODELS

(71) Applicant: Facebook, Inc., Menlo Park, CA (US)

(72) Inventors: Miaoqing Fang, Menlo Park, CA (US); Jesse William Czelusta, San Francisco, CA (US)

(21) Appl. No.: 15/403,118

(22) Filed: Jan. 10, 2017

(51) Int. Cl. G06N 99/00

(52) U.S. Cl. CPC G06N 99/005

(57) ABSTRACT

Systems, methods, and non-transitory computer readable media are configured to obtain a first identifier and a second identifier for at least one entity constituting potential features to train a machine learning model. The first identifier and the second identifier are applied to an embedding model for generating vector representations in a vector space associated with a desired feature dimensionality. A first vector representation associated with the first identifier and a second vector representation associated with the second identifier are applied as features to train the machine learning model.

### FIELD OF THE INVENTION

The present technology relates to the field of machine learning. More particularly, the present technology relates to techniques for reducing feature dimensionality.

### BACKGROUND

Machine learning is a field in computer science related to artificial intelligence. Machine learning allows computers to learn without being expressly programmed. Machine learning involves construction of algorithms that can learn and make predictions from data. The algorithms can operate by building a model from an example training set of input observations in order to make data-driven predictions or decisions expressed as outputs. In machine learning, a model can be trained with features. A feature is an individual measurable property of a phenomenon being observed. The selection of features is an important consideration in creating accurate models.

### SUMMARY

Various embodiments of the present technology can include systems, methods, and non-transitory computer readable media configured to obtain a first identifier and a second identifier for at least one entity constituting potential features to train a machine learning model. The first identifier and the second identifier are applied to an embedding model for generating vector representations in a vector space associated with a desired feature dimensionality. A first vector representation associated with the first identifier and a second vector representation associated with the second identifier are applied as features to train the machine learning model.

In an embodiment, the obtaining a first identifier and a second identifier for at least one entity comprises obtaining a plurality of identifiers for a plurality of entities constituting potential features to train the machine learning model. The systems, methods, and non-transitory computer readable media are further configured to determine an original feature dimensionality based on the plurality of identifiers for the plurality of entities. The original feature dimensionality is reduced to the desired feature dimensionality.

In an embodiment, the desired feature dimensionality is less than the original feature dimensionality by a plurality of orders of magnitude.

In an embodiment, the systems, methods, and non-transitory computer readable media are further configured to select the desired feature dimensionality based at least in part on an amount of available training data for the machine learning model.

In an embodiment, the systems, methods, and non-transitory computer readable media are further configured to generate the first vector representation associated with the first identifier and the second vector representation associated with the second identifier based on the embedding model.

In an embodiment, the obtaining a first identifier and a second identifier for at least one entity comprises obtaining the first identifier for a first entity and the second identifier for the first entity. The systems, methods, and non-transitory computer readable media are further configured to associate the first identifier for the first entity with a first vector representation in the vector space. The second identifier for the first entity is associated with a second vector representation in the vector space that is within a threshold distance from the first vector representation.

In an embodiment, the first entity is associated with a plurality of identifiers, including the first identifier and the second identifier, relating to at least one of a formal name, a nickname, a misspelling, and a name of an associated sub entity.

In an embodiment, the obtaining a first identifier and a second identifier for at least one entity comprises obtaining the first identifier for a first entity and the second identifier for a second entity similar to the first entity. The systems, methods, and non-transitory computer readable media are further configured to associate the first identifier for the first entity with a first vector representation in the vector space. The second identifier for the second entity is associated with a second vector representation in the vector space that is within a threshold distance from the first vector representation.

In an embodiment, similarity between the first entity and the second entity is indicated by training data and related contextual information in which the first entity and the second entity are reflected.

In an embodiment, the at least one entity is an academic institution reflected in resume data and the machine learning model is trained to identify job candidates for an organization.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example machine learning module, according to an embodiment of the present technology.

FIG. 2 illustrates an example feature determination module, according to an embodiment of the present technology.

FIG. 3 illustrates an example scenario for reducing a feature set based on an embedding model, according to an embodiment of the present technology.

FIG. 4 illustrates an example method to train a machine learning model with vector representations in a vector space associated with a desired feature dimensionality based on an embedding model, according to an embodiment of the present technology.

FIG. 5 illustrates an example method to reduce feature dimensionality, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Feature Reduction Based on Embedding Models

As discussed, machine learning is a field in computer science related to artificial intelligence. Machine learning allows computers to learn without being explicitly programmed. Machine learning involves construction of algorithms that can learn from and make predictions on data. The algorithms can operate by building a model from an example training set of input observations in order to make data-driven predictions or decisions expressed as outputs. In machine learning, a model can be trained on features. A feature is an individual measurable property of a phenomenon being observed. The determination of features is an important consideration in creating accurate models.

A problem associated with machine learning relates to feature dimensionality that is not optimal in size. For instance, when only a relatively small number of training samples with which to train a machine learning model is available, a relatively large feature dimensionality can be disadvantageous. For example, accuracy of the machine learning model can be compromised due to overfitting. A machine learning model that has been overfit can suffer poor predictive performance because it overreacts to minor fluctuations in training data. The problem of relatively large feature dimensionality can occur in various applications. In one example application, a relatively large feature dimensionality can hinder performance of machine learning models designed to identify suitable job candidates for job positions of an organization. The training can be based on various training data, including, for example, positive samples of resumes associated with job candidates who successfully secured employment with the organization. The machine learning model can be trained on various features, such as a feature related to an academic institution of higher education (e.g., college or university) attended by the job candidate. In this example, each academic institution can be associated with various identifiers, such as names, variations on the names (e.g., formal names, abbreviations, nicknames, etc.), and misspellings. In conventional machine learning techniques, each identifier often constitutes its own feature, resulting in excessively high values of feature dimensionality. When combined with a relatively small number of training data (e.g., positive samples), excessively high values of feature dimensionality can result in a machine learning model with poor predictive capability.

An improved approach rooted in computer technology overcomes the foregoing and other disadvantages associated with conventional approaches specifically arising in the realm of computer technology. Systems, methods, and computer readable media of the present technology can reduce feature dimensionality of identifiers for entities constituting potential features for training a machine learning model. The present technology can address, for example, identifiers relating to various names for an entity and identifiers for different entities that are similar. The reduction in feature dimensionality can be facilitated by a suitable embedding model. A determination can be made that an original feature dimensionality of a feature set for the machine learning model is not optimal. As a result, a desired feature dimensionality for the machine learning model can be selected. The desired feature dimensionality can represent a reduction in the original feature dimensionality. The selection of the desired feature dimensionality can be based on a variety of considerations, such as an amount of available training data and a desired accuracy for the model. Based on the desired feature dimensionality, the embedding model can be developed. The embedding model can be trained to receive input data and to map the input data into a vector space having a number of dimensions equal to the desired feature dimensionality. Each dimension in the vector space can correspond to a feature. The embedding model can be trained to map various identifiers for an entity to similar locations in the vector space. Further, the embedding model can be trained so that different entities that are similar are mapped to similar locations in the vector space. Based on its location in the vector space, each identifier for an entity can be represented by a vector representation reflecting feature values for features associated with the desired feature dimensionality. The vector representation of the identifier can constitute streamlined training data that can be used to more optimally train the machine learning model. More details regarding the present technology are described herein.

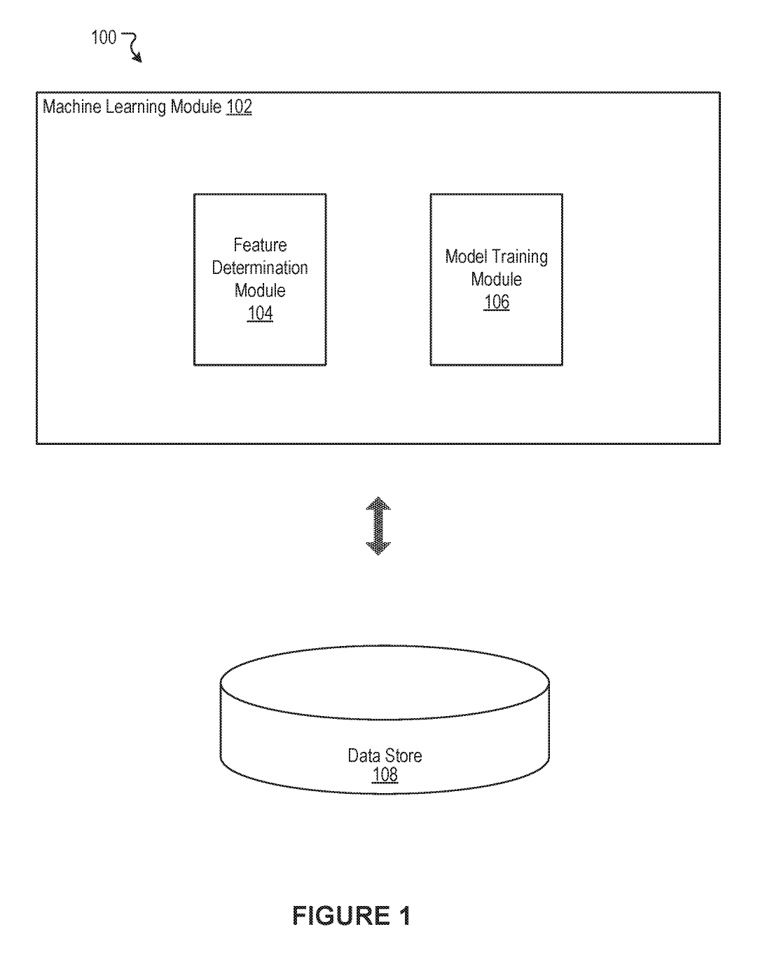

FIG. 1 illustrates an example system 100 including an example machine learning module 102 configured to reduce feature dimensionality of training data to train a machine learning model, according to an embodiment of the present technology. The machine learning module 102 can be used for any suitable application of a machine learning model. In some embodiments, the machine learning module 102 can streamline a feature set associated with identifiers for entities selected as potential features for training a machine learning model. For example, the machine learning module 102 can perform entity resolution in connection with an entity associated with a plurality of identifiers, such as a formal name of the entity, informal names of the entity, abbreviations for the entity, misspelled names of the entity, names of sub entities associated with the entity, etc. In addition, the machine learning module 102 can streamline processing of identifiers for similar entities. Similar entities can be a plurality of distinct entities that, as indicated from input data or its contextual information in which the similar entities are reflected, can be considered similar to one another.

In one instance, the machine learning module 102 can obtain identifiers for a plurality of entities from resume data for the purpose of identifying highly qualified job candidates for an organization. As one example, the plurality of entities can include certain academic institutions reflected in the resume data. An academic institution, as one example of an entity, can be associated with myriad identifiers that all refer to that academic institution. In addition, identifiers can be obtained for a first academic institution and a second academic institution that is similar to the first academic institution. The identifiers can constitute potential features to train a machine learning model to identify job candidates. For even a moderate number of academic institutions of interest, identifiers for the academic institutions can be associated with an original feature dimensionality that is undesirably large. Accordingly, the machine learning module 102 can reduce the original feature dimensionality to generate a desired feature dimensionality. For the identifiers, the machine learning module 102 can utilize one or more embedding models to generate vector representations in a vector space having a number of dimensions equal to the desired feature dimensionality. The vector representations of the identifiers can be used to train a machine learning model to identify highly qualified job candidates.

The present technology can apply to other types of applications for other types of organizations involving other types of entities. For example, in connection with machine learning models to identify job candidates, the present technology can be applied to identifiers for employers and other types of entities in addition to academic institutions. In addition, the present technology can be used for any other application to streamline identifiers for entities that can constitute potential features to train a machine learning model. Likewise, the present technology can be used by any organization in any industry for any suitable purpose. As just one example, the machine learning module 102 can be used to streamline identifiers for entities, such as geographic regions, as potential features to train a machine learning model to target advertisements to appropriate audiences. For example, a city can be associated with many identifiers. As another example, different cities that are similar can be associated with different identifiers. Streamlining of identifiers for entities performed in accordance with the present technology can reduce feature dimensionality to optimize training of machine learning models.

The machine learning module 102 can include a feature determination module 104 and a model training module 106. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the machine learning module 102 can be implemented in any suitable combinations.

The feature determination module 104 can determine a desired feature dimensionality to represent identifiers for selected entities that constitute a potential feature set to train a machine learning model. The desired feature dimensionality to represent identifiers for the entities can be less than an original feature dimensionality. Based on the desired feature dimensionality, the feature determination module 104 can create an embedding model associated with a vector space having a number of dimensions equal to the desired feature dimensionality. The identifiers for the entities can be represented in the vector space so that identifiers relating to various names of an entity and identifiers relating to different entities that are similar are located within a threshold distance from one another in the vector space. The identifiers for the entities and their associated vector representations in the vector space constitute features and feature values that can be used to train the machine learning model. In one example application, the entities can include particular academic institutions reflected in training data, and the machine learning model can be trained to identify highly qualified job candidates for an organization. The feature determination module 104 is discussed in more detail herein.

The model training module 106 can receive vector representations as features and associated feature values for identifiers of selected entities, as determined by the feature determination module 104. The features and associated feature values associated with the vector representations can constitute at least a portion of a feature set that is used to train a machine learning model. Training of the machine learning model is optimized because the features and associated feature values used to represent identifiers for the entities are reduced in feature dimensionality in comparison to an original feature dimensionality. As a result, training of the machine learning model can yield improved predictive capability and can be performed more efficiently.

In an example application relating to a machine learning model to identify highly qualified job candidates for an organization, the model training module 106 can receive training data for the machine learning model that includes vector representations of identifiers for entities relating to names of particular academic institutions of interest to the organization. Training data for the machine learning model can include positive samples associated with job candidates who have achieved some measure of success in a recruiting process associated with the organization. For example, the positive samples can reflect job candidates who have been screened by recruiters, job candidates for whom outreach by recruiters has been performed, or job candidates who have otherwise advanced to some milestone in the recruiting process. Especially for an organization that is very selective in its recruiting process or otherwise has relatively few positive samples from which to draw, reduced feature dimensionality in accordance with the present technology can be important in development of an accurate machine learning model.

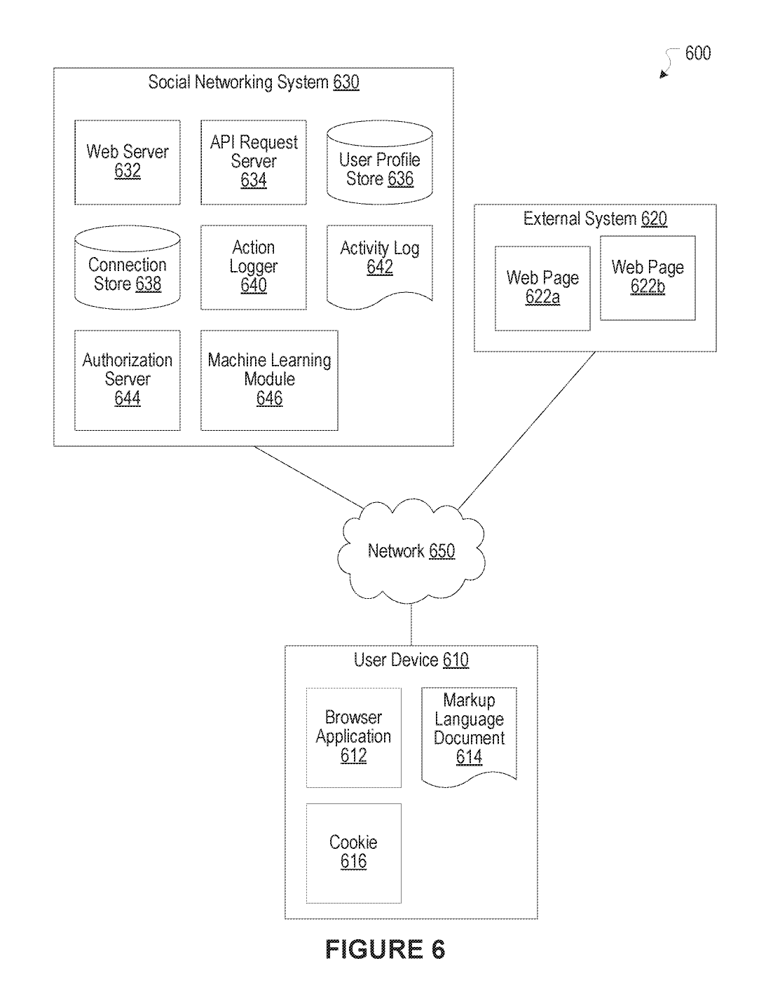

In some embodiments, the machine learning module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the machine learning module 102 can be, in part or in whole, implemented as software running on one or more computing devices or systems, such as on a server or a client computing device. For example, the machine learning module 102 can be, in part or in whole, implemented within or configured to operate in conjunction or be integrated with a social networking system (or service), such as a social networking system 630 of FIG. 6. As another example, the machine learning module 102 can be implemented as or within a dedicated application (e.g., app), a program, or an applet running on a user computing device or client computing system. In some instances, the machine learning module 102 can be, in part or in whole, implemented within or configured to operate in conjunction or be integrated with client computing device, such as a user device 610 of FIG. 6. It should be understood that many variations are possible.

The system 100 can include a data store 108 configured to store and maintain various types of data, such as the data relating to support of and operation of the machine learning module 102. The data can include, for example, identifiers associated with entities, original feature dimensionality, desired feature dimensionality, embedding models, features values, machine learning models, training data, etc. The data store 108 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the machine learning module 102 can be configured to communicate and/or operate with the data store 108.

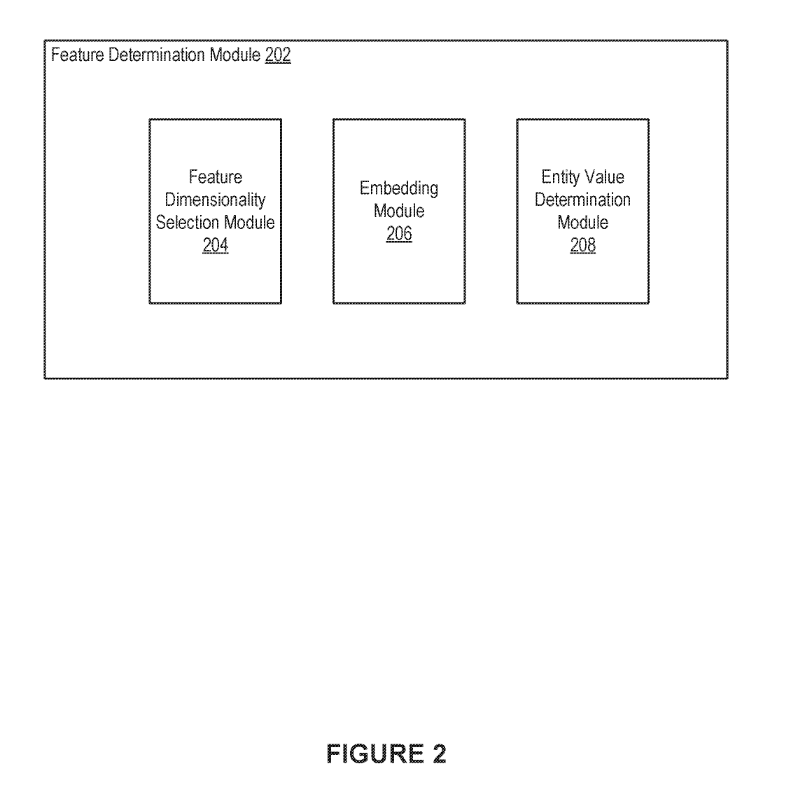

FIG. 2 illustrates an example feature determination module 202, according to an embodiment of the present technology. In some embodiments, the feature determination module 104 of FIG. 1 can be implemented with the feature determination module 202. The feature determination module 202 can include a feature dimensionality selection module 204, an embedding module 206, and an entity value determination module 208.

The feature dimensionality selection module 204 can determine identifiers for entities constituting potential features to train a machine learning model. A particular entity can be selected as a potential feature based on its relevance or importance in a predictive analysis performed by the machine learning model. In some instances, a plurality of identifiers for a variously named entity can constitute features for training the machine learning model. The plurality of identifiers for the variously named entity can include a formal name of the entity, informal names of the entity, abbreviations for the entity, misspelled names of the entity, names of sub entities associated with the entity, etc. In some instances, one or more entities can be considered similar to an entity selected as a potential feature. In this regard, identifiers for the similar entities also can constitute features for training the machine learning model. In a conventional technique, each identifier relating to a variously named entity or an entity deemed similar to another entity can be associated with a potential feature. An original feature dimensionality associated with the conventional technique can include a sum total of all potential features associated with all identifiers. In many instances, the original feature dimensionality can be undesirably large.

For example, in an example application of a machine learning model relating to identification of highly qualified job candidates for a job position with an organization in accordance with a conventional approach, it may be determined that particular entities, such as predetermined academic institutions attended by job candidates, can be indicative of highly qualified job candidates. The predetermined academic institutions may include particular universities (or colleges, schools, academic programs, research institutes, etc.) from which high performing employees of the organization have graduated or universities having strong reputations in disciplines of interest to the organization. In one instance, one such particular entity can relate to a variously named academic institution (e.g., Massachusetts Institute of Technology). A plurality of identifiers for the variously named institution can exist (e.g., “Massachusetts Institute of Technology”, “Massachusetts Institute of Technology”, “Massachusetts Inst of Tech”, “Mass. Tech”, “MA Inst Tech”, “MIT”, “M.I.T.”, “Sloan”, “Slone”, etc.). Each identifier of the plurality of identifiers for various entities can constitute a feature to train a machine learning model. For applications involving a moderate number of academic institutions, it can be seen that an original feature dimensionality can be relatively large in such a conventional approach.

The feature dimensionality selection module 204 can select a desired feature dimensionality from the original feature dimensionality. The desired feature dimensionality can represent a reduction in the original feature dimensionality. The selection of the desired feature dimensionality by the feature dimensionality selection module 204 can be based on maximizing predictive capabilities of a machine learning model while reducing or avoiding problems associated with overfitting and features that are correlated with one another. The selection of the desired feature dimensionality by the feature dimensionality selection module 204 can be based on a variety of considerations, such as an amount of available training data (e.g., size of training corpus) and a desired accuracy (or resolution) for the model. Further, the feature dimensionality selection module 204 can select the desired feature dimensionality based on considerations relating to improvements in efficiency, such as impacts on processing time and storage requirements. In some embodiments, the selection of the desired feature dimensionality by the feature dimensionality selection module 204 is configurable to match the preferences or requirements for a particular application. In some embodiments, the selection of the desired feature dimensionality by the feature dimensionality selection module 204 can be empirically determined based at least in part on administrators responsible for management of the machine learning module 102. In an example relating to an application of a machine learning model relating to identification of highly qualified job candidates for a job position with an organization, assume that, in one instance, a value of an original feature dimensionality based on identifiers for certain academic institutions can be on an order of hundreds of thousands. Based on the considerations discussed herein, the feature dimensionality selection module 204 can select a desired feature dimensionality that is less than the original feature dimensionality. In one instance, the desired feature dimensionality can be selected to be a plurality of orders of magnitude less than the original feature dimensionality. In one implementation, the feature dimensionality selection module 204 can select a desired feature dimensionality to have a value of approximately 100 when available training data in the form of a resume corpus is approximately two million resumes. Many variations are possible.

The embedding module 206 can include one or more embedding models to create vector representations of identifiers for entities in a vector space based on the desired feature dimensionality. An embedding model can be trained with input data that includes identifiers for entities that can constitute potential features for training a machine learning model. The embedding model can convert identifiers for entities into vector representations in the vector space. The vector space can have a number of dimensions equal to the desired feature dimensionality. Based on the embedding model, identifiers associated with a variously named entity are mapped in the vector space so that their vector representations are within a threshold distance from one another or otherwise in proximity to one another. In addition, with respect to different entities that are similar to one another in one or more relevant aspects, identifiers for the different entities are likewise mapped in the vector space based on the embedding model so that their vector representations are within a threshold distance from one another or otherwise in proximity to one another. Any suitable embedding technique can be used in accordance with the present technology. In some embodiments, an embedding technique based on a word2vec technique or a tag space technique can be used.

In an example application of a machine learning model relating to identification of highly qualified job candidates for a job position with an organization, input data can include a resume corpus of any suitable number (e.g., approximately 2 million) of resumes (or curricula vitae). The input data can be used as a bag of words to train an embedding model. The embedding model can be associated with a vector space configured to have a number of dimensions equal to a desired feature dimensionality (e.g., approximately 100). For entities relating to academic institutions, the embedding model can be trained so that identifiers for a variously named academic institution are associated with vector representations that are in proximity in the vector space. For example, the embedding model can map vector representations of a first identifier (e.g., “Massachusetts Institute of Tech”), a second identifier (e.g., “Mass Inst Tech”), a third identifier (e.g., “MIT”), and a fourth identifier (e.g., “Slone”), etc. for an academic institution (e.g., Massachusetts Institute of Technology) in the vector space to be within a threshold distance from one another. In addition, for entities relating to academic institutions, the embedding model can be trained so that identifiers for similar entities are associated with vector representations that are in proximity in the vector space. Similarity of the entities can be indicated by the resume corpus and its contextual information. For example, when a first academic institution (e.g., Massachusetts Institute of Technology), a second academic institution (e.g., California Institute of Technology), and a third academic institution (e.g., Harvard) are similar to one another, the embedding model can map vector representations of their identifiers in the vector space to be within a threshold distance from one another. While this example application relates to academic institutions as a type of entity, the embedding module 102 can be used for other types of entities (e.g., employers) reflected in the input data.

The entity value determination module 208 can apply a trained embedding model to determine a vector representation in a vector space for an identifier for an entity. In some embodiments, the vector representation can be an array having one or more values. The identifier for the entity may be selected for consideration as a feature to train a machine learning model. The vector representation of the identifier for the entity can reflect a number of dimensions that is equal to the desired feature dimensionality as well as a value for each dimension. In some embodiments, the value for each dimension of the vector representation can be a real number. The vector representation of the identifier for the entity can be provided to the model training module 106 to train the machine learning model. In an example application relating to a machine learning model relating to identification of highly qualified job candidates for a job position with an organization, academic institutions can be used as potential features to train the machine learning model. Identifiers for the academic institutions can be applied to the embedding model to generate vector representations of the academic institutions that reflect a desired feature dimensionality. The vector representations of the identifiers for the academic institutions can be used to train the machine learning model. The desired feature dimensionality can optimize training of the machine learning model.

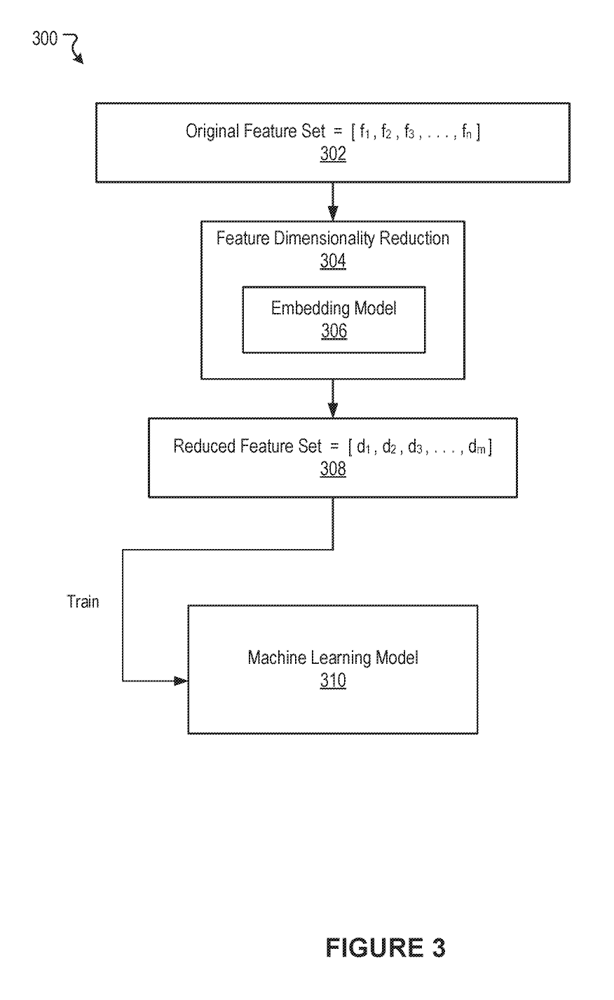

FIG. 3 illustrates an example scenario 300 for reducing feature dimensionality to train a machine learning model, according to an embodiment of the present technology. With respect to the scenario 300, identifiers for entities reflected in training data can be selected as potential features to train a machine learning model 310. The machine learning model 310 can be trained to perform any suitable predictive analysis or classification. The identifiers for the entities can be expressed as an original feature set 302. The original feature set 302 can reflect an original feature dimensionality having a value n. Accordingly, as shown, the original feature set 302 can be expressed as an array of n feature values with each feature value having a value

To optimize the original feature set 302 for training the machine learning model 310, feature dimensionality reduction 304 can be performed. In this regard, a desired feature dimensionality can be selected. The desired feature dimensionality can be a reduction in original feature dimensionality. In some embodiments, the desired feature dimensionality can be selected empirically based on a variety of considerations. Such considerations can include, for example, a size of the training data, desired accuracy of the machine learning model, and efficiency factors. The desired feature dimensionality can be applied to an embedding model 306. The embedding model 306 can map the identifiers as vector representations in a vector space having a number of dimensions equal to the desired feature dimensionality. As discussed herein, identifiers for a variously named entity can be associated with vector representations that are within a threshold proximity from one another. In addition, identifiers for similar entities likewise can be associated with vector representations that are within a threshold proximity from one another. Based on the embedding model 306, the identifiers for the entities can be expressed as a reduced feature set 308. The reduced feature set 308 can reflect a desired feature dimensionality having a value m, where m<n. The reduced feature set 308 can be expressed as an array of m feature values with each feature value having a value dᵢ. In some embodiments, the value dᵢ can be a real number.

The reduced feature set 308 can be applied to the machine learning model 310 to train the machine learning model 310. In comparison to the original feature set 302, the reduced feature set 308 can optimize training of the machine learning model 310. As a result, the machine learning model 310 can provide improved predictive analysis even when available training data to train the machine learning model 310 is relatively small.

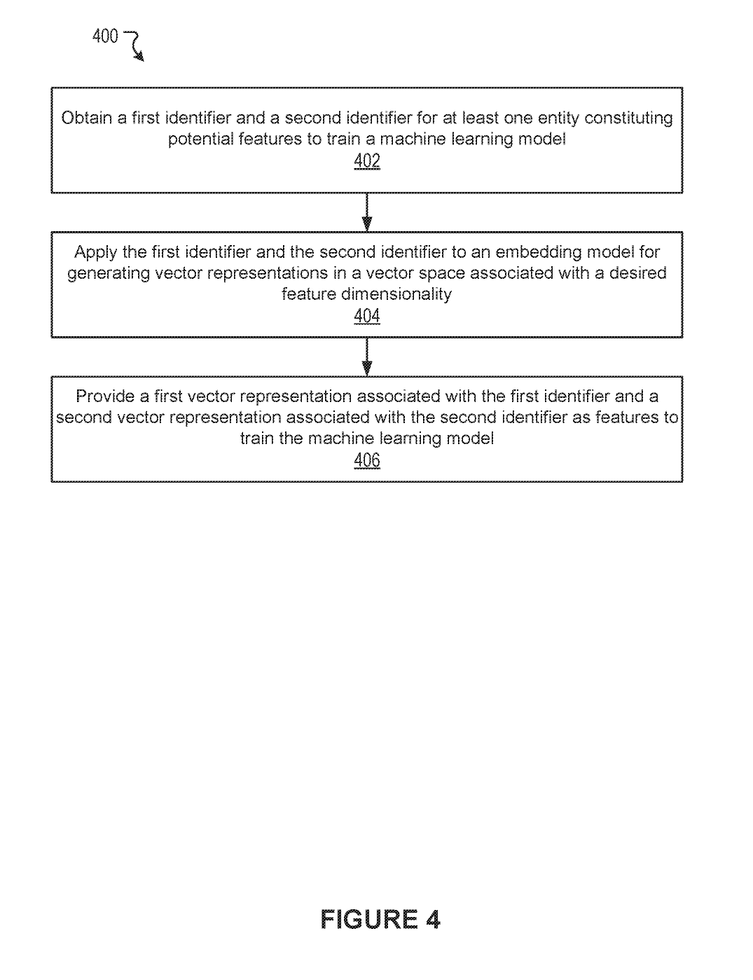

FIG. 4 illustrates an example method 400 to train a machine learning model with vector representations in a vector space associated with a desired feature dimensionality based on an embedding model, according to an embodiment of the present technology. It should be appreciated that there can be additional, fewer, or alternative steps performed in similar or alternative orders, or in parallel, in accordance with the various embodiments and features discussed herein unless otherwise stated.

At block 402, the method 400 can obtain a first identifier and a second identifier for at least one entity constituting potential features to train a machine learning model. At block 404, the method 400 can apply the first identifier and the second identifier to an embedding model for generating vector representations in a vector space associated with a desired feature dimensionality. At block 406, the method 400 can provide a first vector representation associated with the first identifier and a second vector representation associated with the second identifier as features to train the machine learning model. Other suitable techniques that incorporate various features and embodiments of the present technology are possible.

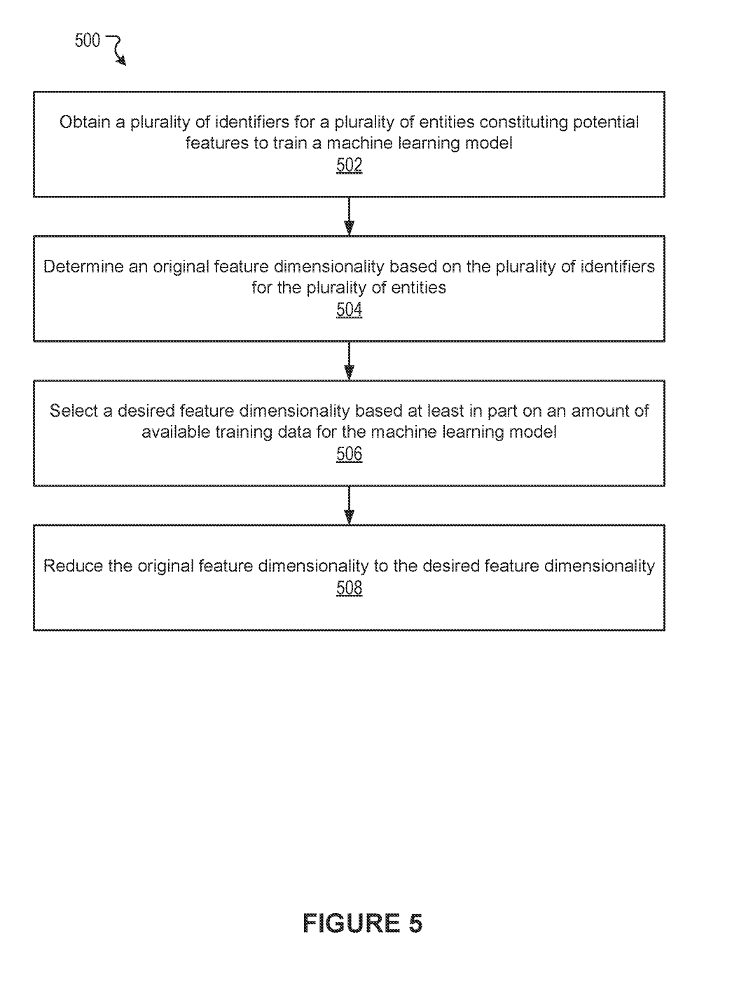

FIG. 5 illustrates a first example method 500 to reduce feature dimensionality, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can obtain a plurality of identifiers for a plurality of entities constituting potential features to train a machine learning model. At block 504, the method 500 can determine an original feature dimensionality based on the plurality of identifiers for the plurality of entities. At block 506, the method 500 can select a desired feature dimensionality based at least in part on an amount of available training data for the machine learning model. At block 508, the method 500 can reduce the original feature dimensionality to the desired feature dimensionality. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System-Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a machine learning module 646. The machine learning module 646 can be implemented with the machine learning module 102, as discussed in more detail herein. In some embodiments, one or more functionalities of the machine learning module 646 can be implemented in the user device 610.

### Hardware Implementation

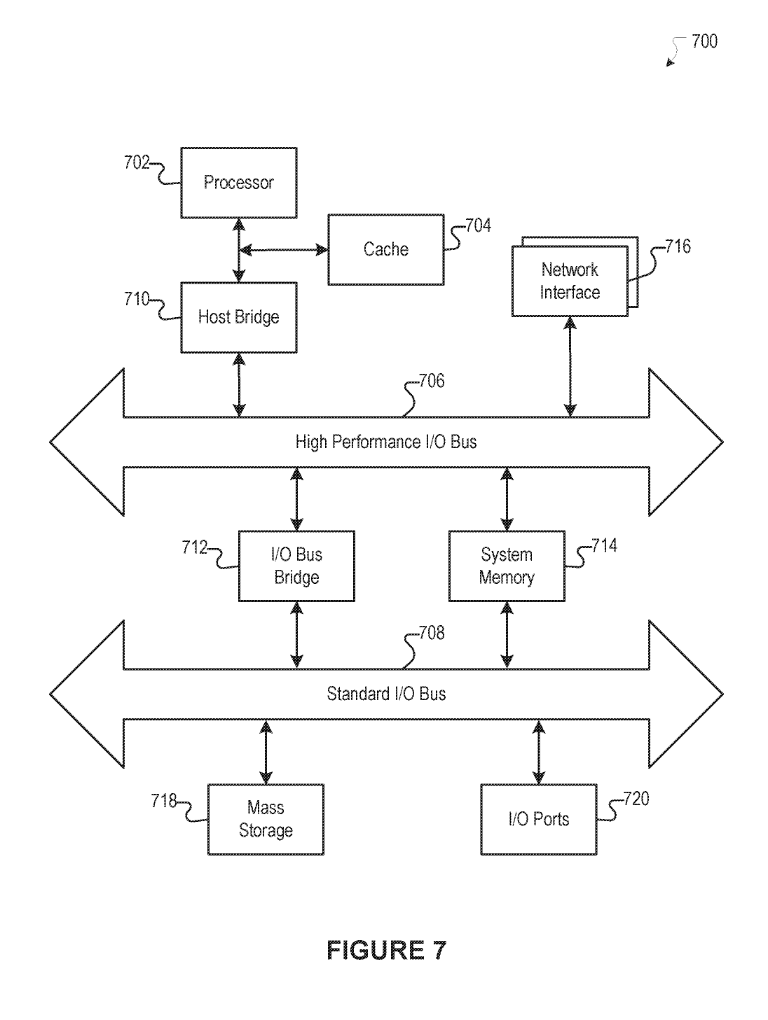

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a first identifier and a second identifier for at least one entity constituting potential features to train a machine learning model;
applying, by the computing system, the first identifier and the second identifier to an embedding model for generating vector representations in a vector space associated with a desired feature dimensionality; and
providing, by the computing system, a first vector representation associated with the first identifier and a second vector representation associated with the second identifier as features to train the machine learning model.

2. The computer-implemented method of claim 1, wherein the obtaining a first identifier and a second identifier for at least one entity comprises obtaining a plurality of identifiers for a plurality of entities constituting potential features to train the machine learning model, the method further comprising:
determining an original feature dimensionality based on the plurality of identifiers for the plurality of entities; and
reducing the original feature dimensionality to the desired feature dimensionality.

3. The computer-implemented method of claim 2, wherein the desired feature dimensionality is less than the original feature dimensionality by a plurality of orders of magnitude.

4. The computer-implemented method of claim 1, further comprising:
selecting the desired feature dimensionality based at least in part on an amount of available training data for the machine learning model.

5. The computer-implemented method of claim 1, further comprising:
generating the first vector representation associated with the first identifier and the second vector representation associated with the second identifier based on the embedding model.

6. The computer-implemented method of claim 1, wherein the obtaining a first identifier and a second identifier for at least one entity comprises obtaining the first identifier for a first entity and the second identifier for the first entity, the method further comprising:
associating the first identifier for the first entity with a first vector representation in the vector space; and
associating the second identifier for the first entity with a second vector representation in the vector space that is within a threshold distance from the first vector representation.

7. The computer-implemented method of claim 6, wherein the first entity is associated with a plurality of identifiers, including the first identifier and the second identifier, relating to at least one of a formal name, a nickname, a misspelling, and a name of an associated sub entity.

8. The computer-implemented method of claim 1, wherein the obtaining a first identifier and a second identifier for at least one entity comprises obtaining the first identifier for a first entity and the second identifier for a second entity similar to the first entity, the method further comprising:
associating the first identifier for the first entity with a first vector representation in the vector space; and
associating the second identifier for the second entity with a second vector representation in the vector space that is within a threshold distance from the first vector representation.

9. The computer-implemented method of claim 8, wherein similarity between the first entity and the second entity is indicated by training data and related contextual information in which the first entity and the second entity are reflected.

10. The computer-implemented method of claim 1, wherein the at least one entity is an academic institution reflected in resume data and the machine learning model is trained to identify job candidates for an organization.

11. A system comprising:
at least one processor; and
a memory storing instructions that, when executed by the at least one processor, cause the system to perform:
obtaining a first identifier and a second identifier for at least one entity constituting potential features to train a machine learning model;
applying the first identifier and the second identifier to an embedding model for generating vector representations in a vector space associated with a desired feature dimensionality; and
providing a first vector representation associated with the first identifier and a second vector representation associated with the second identifier as features to train the machine learning model.

12. The system of claim 11, wherein the obtaining a first identifier and a second identifier for at least one entity comprises obtaining a plurality of identifiers for a plurality of entities constituting potential features to train the machine learning model, the system further comprising:
determining an original feature dimensionality based on the plurality of identifiers for the plurality of entities; and
reducing the original feature dimensionality to the desired feature dimensionality.

13. The system of claim 11, further comprising:
selecting the desired feature dimensionality based at least in part on an amount of available training data for the machine learning model.

14. The system of claim 11, further comprising:
generating the first vector representation associated with the first identifier and the second vector representation associated with the second identifier based on the embedding model.

15. The system of claim 11, wherein the obtaining a first identifier and a second identifier for at least one entity comprises obtaining the first identifier for a first entity and the second identifier for the first entity, the system further comprising:
associating the first identifier for the first entity with a first vector representation in the vector space; and
associating the second identifier for the first entity with a second vector representation in the vector space that is within a threshold distance from the first vector representation.

16. A non-transitory computer-readable storage medium including instructions that, when executed by at least one processor of a computing system, cause the computing system to perform a method comprising:
obtaining a first identifier and a second identifier for at least one entity constituting potential features to train a machine learning model;
applying the first identifier and the second identifier to an embedding model for generating vector representations in a vector space associated with a desired feature dimensionality; and
providing a first vector representation associated with the first identifier and a second vector representation associated with the second identifier as features to train the machine learning model.

17. The non-transitory computer-readable storage medium of claim 16, wherein the obtaining a first identifier and a second identifier for at least one entity comprises obtaining a plurality of identifiers for a plurality of entities constituting potential features to train the machine learning model, the method further comprising:
determining an original feature dimensionality based on the plurality of identifiers for the plurality of entities; and
reducing the original feature dimensionality to the desired feature dimensionality.

18. The non-transitory computer-readable storage medium of claim 16, further comprising:
selecting the desired feature dimensionality based at least in part on an amount of available training data for the machine learning model.

19. The non-transitory computer-readable storage medium of claim 16, further comprising:
generating the first vector representation associated with the first identifier and the second vector representation associated with the second identifier based on the embedding model.

20. The non-transitory computer-readable storage medium of claim 16, wherein the obtaining a first identifier and a second identifier for at least one entity comprises obtaining the first identifier for a first entity and the second identifier for the first entity, the method further comprising:
associating the first identifier for the first entity with a first vector representation in the vector space; and
associating the second identifier for the first entity with a second vector representation in the vector space that is within a threshold distance from the first vector representation.
